(19) United States
(12) Patent Application Publication
(10) Pub. No.: US 2013/0058010 A1
(43) Pub. Date: Mar. 7, 2013

(54) METAL CURRENT COLLECTOR, METHOD FOR PREPARING THE SAME, AND ELECTROCHEMICAL CAPACITORS WITH SAME

(71) Applicants: Hak Kwan Kim, Seoul (KR); Jun Hee Bae, Seoul (KR); Bae Kyun Kim, Seongnam (KR)

(72) Inventors: Hak Kwan Kim, Seoul (KR); Jun Hee Bae, Seoul (KR); Bae Kyun Kim, Seongnam (KR)

(73) Assignee: Samsung Electro-Mechanics Co., Ltd., Suwon (KR)

(21) Appl. No.: 13/480,060

(22) Filed: May 24, 2012

(30) Foreign Application Priority Data
Sep. 6, 2011 (KR) 10-2011-0090171

(51) Int. Cl. H01G 9/004; H01G 13/00

(52) U.S. Cl. 361/523; 427/79; 216/17

(57) ABSTRACT

A metal current collector including a metal substrate having grooves formed along a triple junction line of a surface thereof and a conductive layer formed on the metal substrate, a method for preparing the same, and electrochemical capacitors with same. A metal current collector including a metal substrate having grooves formed along a triple junction line of a surface thereof and a conductive layer formed on the metal substrate has a large surface area and low electrical resistance. This metal current collector can be effectively used in electrochemical capacitors with high capacity and high output characteristics by improving contact characteristics with an active material layer.

### CROSS-REFERENCE TO RELATED APPLICATIONS

Claim and incorporate by reference domestic priority application and foreign priority application as follows:

This application claims the benefit under 35 U.S.C. Section 119 of Korean Patent Application Serial No. 10-2011-0090171, entitled filed Sep. 6, 2011, which is hereby incorporated by reference in its entirety into this application.

### BACKGROUND OF THE INVENTION

1. Field of the Invention

The present invention relates to a metal current collector, a method for preparing the same, and electrochemical capacitors comprising the same.

2. Description of the Related Art

High value-added industries which collect and utilize various useful information in real time through various information and communication devices, are taking the lead in a highly information-oriented age. Stable energy supply has been an important factor to secure reliability of these systems.

Electrical circuit boards are mounted to these information and communication devices and various electronic products, and in each circuit board, there is a component called a capacitor which takes charge of a function of gathering and discharging electricity to stabilize a flow of electricity in a circuit. This capacitor has very short charge and discharge time, long lifespan, and very high output density. However, since the capacitor generally has very low energy density, there are many restrictions on use of the capacitor as an energy storage device.

However, an electrochemical capacitor, a supercapacitor, or an ultracapacitor, which is commercialized in Japan, Russia, and the United States in 1995 and has been developed to increase capacity according to the information-oriented age, is a new category capacitor that is being competitively developed in all countries of the world recently and getting the spotlight as a next generation energy storage device with a secondary battery.

The supercapacitors are classified into three types according to electrode and mechanism: (1) electric double layer capacitor (EDLC) using activated carbon as an electrode and electric double layer charge adsorption as a mechanism, (2) pseudocapacitor or redox capacitor using a transition metal oxide and a conductive polymer as electrode materials and pseudo-capacitance as a mechanism, and (3) hybrid capacitor having intermediate characteristics of the EDLC and an electrolytic capacitor.

Among them, as shown in FIG. 1, currently, an EDLC type supercapacitor, which uses an activated carbon material, is most used.

Referring to this, a basic structure of the supercapacitor consists of porous electrodes 10 and 20, an electrolyte 30, current collectors 11 and 21, and a separator (not shown) and uses an electrochemical mechanism, which occurs when ions 31 and 32 in the electrolyte 30 move along an electric field and are adsorbed on a surface of the unit cell electrode by a voltage of several volts applied to both ends of the unit cell electrode, as an operation principle.

Typically, since specific capacitance is proportional to a specific surface area, it is possible to manufacture a supercapacitor with high energy density according to high capacity by using activated carbon given with porosity as an electrode material.

Meanwhile, the electrodes (cathode and anode 10 and 20) are prepared by coating electrode active material slurry including a carbon active material, a conductive agent, and a binder resin on respective current collectors. At this time, studies for increasing adhesion with the current collector while reducing contact resistance by changing the kind and ratio of the binder resin, the conductive agent, and the electrode active material and for reducing internal contact resistance between activated carbon are most important.

In case of the pseudocapacitor or redox capacitor, a transition metal oxide is advantageous in terms of capacity but has lower resistance than activated carbon so that a supercapacitor with high output characteristics can be manufactured. In recent times, it has been reported that specific capacitance is remarkably increased when using an amorphous hydrate as an electrode material.

However, in case of the capacitor using the above materials, it has high capacitance compared to the EDLC but more than double manufacturing costs, high difficulty in manufacture, and high equivalent series resistance (ESR).

Therefore, recently, presentations on an electrode, which shows high output and energy density characteristics compared to an existing electrode using only a transition metal oxide by oxidizing only a surface thereof using a nitride with higher electrical conductivity than an oxide, have been made by P. N. Kumta et al. and so on.

Meanwhile, in case of the hybrid capacitor which tries to combine advantages of them, studies for improving an operating voltage and energy density by using asymmetric electrodes have been actively made. It is a capacitor that is capable of improving the overall cell energy by using a material with electric double layer characteristics, that is, a carbon material in one electrode to maintain output characteristics and using an electrode with high output characteristics showing a redox mechanism in the other electrode. Like this, this capacitor can improve capacitance and energy density but has not yet universalized due to unideal characteristics such as charging and discharge characteristics and nonlinearity.

As described above, the most important factor of increasing the capacitance of the supercapacitor is an electrode material with a large specific surface area since the capacitance is proportional to a surface area of the electrode. In addition to this aspect, characteristics such as high electrical conductivity, electrochemical inertness, and easy molding and processability are required and porous carbon materials well suitable for these characteristics are most used. The porous carbon materials are activated carbon, activated carbon fiber, amorphous carbon, carbon aerogel, carbon composite, carbon nanotube, and so on.

However, the above carbon material mostly consists of micropores which do not contribute to an electrode role, in spite of a large specific surface area, and effective pores are just 20% of the entire material.

Moreover, actually, since the electrode is prepared by mixing a binder, a conductive agent, a solvent, and so on and making a mixture into slurry, an actual effective contact area between the electrode and an electrolyte is more reduced. Further, there is a disadvantage that a degree of contact resistance between the electrode and the current collector and a capacitance range are not uniform according to manufacturing methods.

The current collector commonly used in the supercapacitor mainly uses at least one selected from the group consisting of aluminum, stainless steel, titanium, tantalum, niobium, copper, nickel, and alloys thereof, and among them, aluminum is most widely used.

However, the current collector made of aluminum or an aluminum alloy is easily corroded (for example, oxidized). For example, since a surface of the current collector made of aluminum or an aluminum alloy is immediately oxidized when exposed to the air, a native oxide layer is formed usually. However, since the oxide layer formed on the surface of the current collector is an insulating layer, it increases electrical resistance between the current collector and an active material layer.

### SUMMARY OF THE INVENTION

The present invention has been invented in order to overcome the above-described problems in a metal current collector of an electrochemical capacitor and it is, therefore, an object of the present invention to provide a metal current collector of an electrochemical capacitor capable of reducing electrical resistance between the current collector and an active material layer by increasing a contact area between the metal current collector and the active material layer.

Further, it is another object of the present invention to provide a method for preparing a metal current collector of an electrochemical capacitor.

Further, it is still another object of the present invention to provide a high output and high energy density electrochemical capacitor by increasing electrical resistance and a contact area between electrode active material layers using a metal current collector.

In accordance with one aspect of the present invention to achieve the object, there is provided a metal current collector including: a metal substrate having grooves formed along a triple junction line of a surface thereof; and a conductive layer formed on the metal substrate having the grooves.

The metal substrate may be at least one selected from the group consisting of aluminum, stainless steel, titanium, tantalum, niobium, copper, nickel, and alloys thereof.

Preferably, the metal substrate may be aluminum or an alloy thereof.

The metal substrate may have a sheet-like foil, etched foil, expanded metal, punched metal, net, or foam shape.

It is preferred that the grooves formed in the metal sheet have a depth of 0.5 to 1.0 μm.

It is preferred that an interval between the grooves is 1.0 to 3.0 μm.

It is preferred that the conductive layer uses at least one conductive carbon selected from the group consisting of super-p, graphite, cokes, activated carbon, and carbon black.

In accordance with another aspect of the present invention to achieve the object, there is provided a method for preparing a metal current collector including: forming grooves along a triple junction line of a surface of a metal substrate; removing a native oxide layer formed on the metal substrate; and forming a conductive layer on the metal substrate from which the native oxide layer is removed.

The grooves may be formed by locally corroding the triple junction line of the surface of the metal substrate.

The removal of the native oxide layer may be processed by at least one acid solution selected from the group consisting of phosphoric acid, sulfuric acid, nitric acid, hydrochloric acid, acetic acid, carbonic acid, trifluoroacetic acid, oxalic acid, hydrofluoric acid, boric acid, perchloric acid, hypochlorous acid, and mixtures thereof.

The removal of the native oxide layer may be processed by at least one alkaline solution selected from the group consisting of potassium hydroxide, sodium hydroxide, lithium hydroxide, ammonia, and mixtures thereof.

Further, the present invention may provide an electrochemical capacitor comprising a metal current collector.

The metal current collector may be used in one or both selected from a cathode and/or an anode.

In addition, the present invention may provide an electrochemical capacitor comprising an electrode including an electrode active material in the metal current collector.

It is preferred that the electrode active material is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

Preferably, the electrode active material may be activated carbon with a specific surface area of 1.500 to 3.000 m²/g.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram of an electric double layer capacitor (EDLC);

FIG. 2 is a view showing a structure of a metal current collector in accordance with the present invention;

FIG. 3 is an example showing a structure of a metal substrate of the present invention; and

FIG. 4 is a schematic diagram showing a process of preparing the metal current collector in accordance with the present invention.

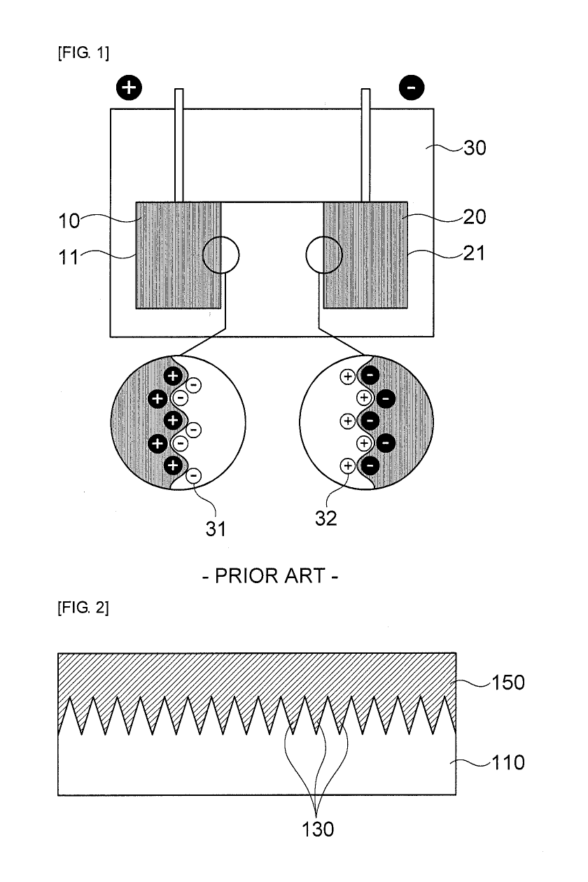

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

The present invention relates to a metal current collector used in an electrochemical capacitor, a method for preparing the same, and electrochemical, capacitors comprising the same.

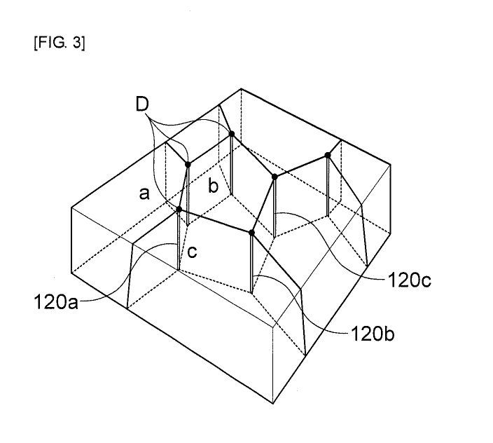

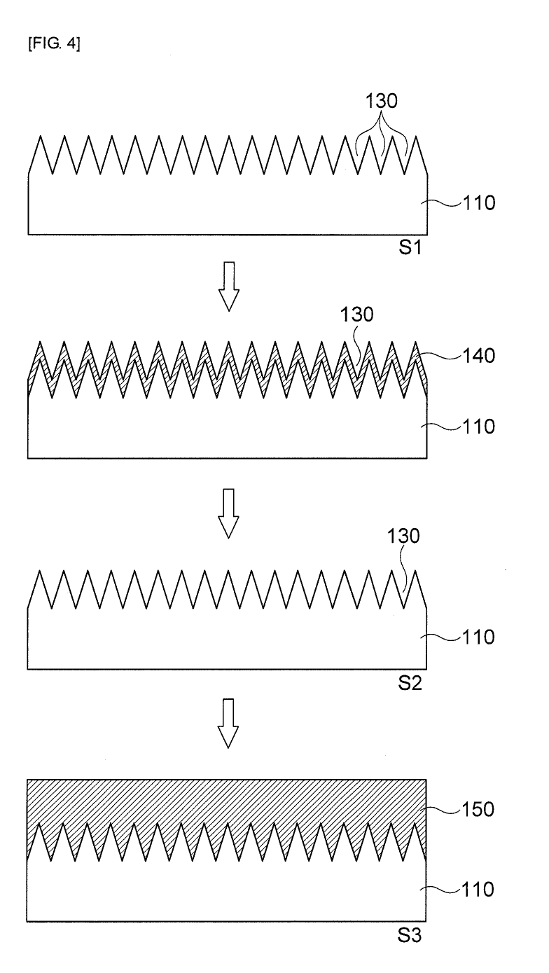

A metal current collector in accordance with an embodiment of the present invention is as shown in the following FIG. 2 and includes a metal substrate 110 having grooves 130 formed along a triple junction line of a surface thereof and a conductive layer 150 formed on the metal substrate 110.

That is, the surface of the metal substrate 110 is locally corroded by using the triple junction line, that is, a kind of line defect to form a nanorod array (grooves) so that a surface area of the current collector is increased.

The triple junction line used in the present invention, which is a line defect 120a, 120b, and 120c occurring along a junction point (D) when more than three grain boundary planes a, b, and c meet one another as shown in the following FIG. 3, is a characteristic of a typical crystalline material.

Therefore, it is known that corrosion is locally formed along the triple junction line 120a, 120b, and 120c through adjustment of process variables such as kind, concentration, and temperature of an etching solution.

In the present invention, by using this characteristic, the surface of the metal substrate 110 is locally corroded along the triple junction line 120a, 120b, and 120c to form the well-aligned grooves 130 in the corroded portions as in FIG. 2 so that it is possible to provide a current collector having a well-aligned structure with a very large effective specific surface area.

The shape of the grooves formed along the triple junction line of the present invention is not particularly limited.

It is preferred that the grooves formed on the metal substrate have a depth of 0.5 to 1.0 μm to minimize an actual non-contact area between an electrode layer and the current collector.

It is preferred that an interval between the grooves formed on the metal substrate is 1.0 to 3.0 μm. When the interval is too small, it is difficult to form the desired grooves due to tunneling of the grooves. On the contrary, when the interval is too large, it is not preferred since the actual contact area between the electrode layer and the current collector is reduced and thus resistance is increased again.

The metal substrate used in the present invention may be at least one selected from the group consisting of aluminum, stainless steel, titanium, tantalum, niobium, copper, nickel, and alloys thereof, and among them, aluminum or an alloy thereof may be preferably used.

The metal substrate may have a sheet-like foil, etched foil, expanded metal, punched metal, net, or form shape, and the shape of the metal substrate is also not particularly limited.

Further, the metal current collector in accordance with the present invention forms the conductive layer 150 on the metal substrate 110 having the grooves 130 formed along the triple junction line.

Typically, since metal such as aluminum is immediately oxidized when exposed to the air, a native oxide layer is formed on the metal substrate having the grooves. However, since this native oxide layer is an insulating layer, it increases electrical resistance between the current collector and an active material layer. Therefore, in the present invention, after the native oxide layer is removed, the conductive layer is formed on the metal substrate. It is possible to maximize rapid discharge of charged charges and reduce resistance on an interface between the current collector and the active material layer by performing conductive coating.

Therefore, since the specific surface area is large compared to an existing current collector which is simply surface-etched and the conductive layer is formed after removing an aluminum oxide layer, an obstacle to electrical conductivity, contact resistance occurring when the charged charges are discharged to the outside is very low. Further, it is possible to improve charging and discharging speed by facilitating rapid diffusion of ions through adjustment of size of the well-aligned grooves.

Therefore, it is preferred that a material of this conductive layer is a material with low electrical conductivity, for example, a material with electrical conductivity of higher than 10 S/cm, preferably, higher than 100 S/cm. This material may be, for example, at least one conductive carbon selected from the group consisting of super-p, graphite, cokes, activated carbon, and carbon black but not limited thereto.

Since the conductive layer of the present invention is formed on the metal substrate having the grooves, the conductive layer may be formed to be buried in the grooves as well as on the surface of the metal substrate. Therefore, a thickness of the conductive layer is 1.0 to 5.0 μm from a surface of the groove of the metal substrate to maximize electrical conductivity while suppressing a reduction in capacitance per unit volume of an electrode. The smaller the thickness of the conductive layer is, the better it is, but when the thickness of the conductive layer is less than 1.0 μm, it is not preferable due to difficulty in a press process, but the thickness of the conductive layer is not particularly limited.

Hereinafter, a method for preparing a metal current collector in accordance with the present invention will be described in detail.

A metal current collector in accordance with the present invention can be prepared by passing through a first step (S1) of forming grooves 130 along a triple junction line of a metal substrate 110, a second step (S2) of removing a native oxide layer 140 formed on the metal substrate 110, and a third step (S3) of forming a conductive layer 150 on the metal substrate 110 from which the native oxide layer 140 is removed.

First, the first step (S1) is a step of forming the grooves 130 by locally corroding a surface of the metal substrate 110 along the triple junction line. Since the triple junction line is a unique characteristic of the metal substrate 110 used, when the metal substrate 110 is locally corroded along the line, the grooves 130 are formed at regular intervals in the corroded portions.

Before locally corroding the metal substrate 110, an appropriate cleaning process can be performed and a method thereof is not particularly limited.

In the drawings of the present invention, although the groove 130 is shown in an uneven shape, the groove 130 may have a rectangular shape or a cylindrical shape and the shape of the groove 130 is not particularly limited. This groove may have a predetermined shape by adjusting the kind, concentration, temperature, and so on of an etching solution used for corrosion.

The etching solution used at this time may be at least one selected from the group consisting of hydrochloric acid, phosphoric acid, fluosilicic acid, and sulfuric acid but not limited thereto.

Further, it is preferred that local corrosion is performed at a temperature of 30 to 70° C. in terms of uniformity and density of etching but not particularly limited thereto.

Meanwhile, when the metal substrate 110 having grooves 130 is exposed to the air, the metal substrate 110 is easily oxidized due to its characteristics so that a thin native oxide layer 140 is formed on the surface of the metal substrate 110. The native oxide layer 140 is naturally formed when exposed to the air, not by an artificial external means. For example, when the metal substrate 110 is aluminum or an alloy thereof, the surface of the metal substrate 110 is naturally oxidized so that an aluminum oxide (Al₂O₃) is formed on the surface of the metal substrate 110.

However, since this native oxide layer 140 increases resistance between the metal current collector and an active material layer, in the present invention, a process of removing the native oxide layer 140 is performed as the second step (S2).

After passing through the process of removing the native oxide layer 140, it becomes a state of the metal substrate of the first step, on which the grooves are formed.

In accordance with an embodiment of the present invention, a chemical method of removing the native oxide layer 140 by immersing the native oxide layer 140 in an appropriate solution or an etching method may be used.

It is preferred that the solution used to remove the native oxide layer may be, for example, at least one acid solution selected from the group consisting of phosphoric acid, sulfuric acid, nitric acid, hydrochloric acid, acetic acid, carbonic acid, trifluoroacetic acid, oxalic acid, hydrofluoric acid, boric acid, perchloric acid, hypochlorous acid, and mixtures thereof.

Further, in accordance with another embodiment of the present invention, the removal of the native oxide layer may use at least one alkaline solution selected from the group consisting of potassium hydroxide, sodium hydroxide, lithium hydroxide, ammonia, and mixtures thereof.

Further, when using an etching method, dry etching is more preferable, and for example, sputter etching may be performed by using various inert gas ions such as argon and nitrogen. However, the etching method is not limited to the sputter etching, and other etching methods can be used.

Finally, the step (S3) of forming the conductive layer 150 on the metal substrate from which the native oxide layer is removed is performed.

A method of forming the conductive layer 150 is not particularly limited, and for example, physical vapor deposition (PVD) such as a sputtering method, an ion plating (IP) method, and an arc ion plating (AIP) method or chemical vapor deposition (CVD) such as a plasma CVD method may be used. Further, the conductive layer 30 may be formed by coating a conductive layer forming material after preparing the conductive layer forming material in the form of slurry. When preparing the conductive layer forming material in the form of slurry, after an appropriate binder is added to the conductive layer forming material, the conductive layer forming material is coated. The binder used at this time may be carboxymethyl cellulose (CMC), styrene-butadiene rubber (SBR), or polyvinylidenfluoride (PVDF) but not limited thereto.

It is preferred that the conductive layer 150 is formed with a thickness of 1.0 to 5.0 μm from an uppermost portion of the groove while filling a buried portion of the groove in order to completely cover the metal substrate 110 having the grooves 130.

It is preferred that a material for forming the conductive layer 150 is at least one conductive powder selected from the group consisting of super-p, graphite, cokes, activated carbon, and carbon black.

It is possible to reduce electrical resistance of the current collector and maximize rapid discharge of charged charges by forming the conductive layer 150.

Further, the present invention may provide an electrochemical capacitor comprising the metal current collector. The metal current collector may be used in one or both selected from a cathode and/or an anode.

An electrochemical capacitor in accordance with the present invention includes an electrode formed by coating an electrode active material slurry composition on the current collector, a separator, and an electrolyte.

The electrode active material slurry composition may be prepared by mixing and agitating an electrode active material, a conductive agent, a binder, a solvent, and other additives.

Preferably, the electrode active material in accordance with the present invention may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

In accordance with a preferable embodiment of the present invention, it is most preferred that the electrode active material may be activated carbon with a specific surface area of 1.500 to 3.000 m²/g.

Further, the conductive agent may include conductive power such as super-p, ketjen black, acetylene black, carbon black, and graphite.

For example, the binder may use at least one selected from fluorine resins such as polytetrafluoroethylene (PTFE) and polyvinylidenfluoride (PVDF); thermoplastic resins such as polyimide, polyamideimide, polyethylene (PE), and polypropylene (PP); cellulose resins such as carboxymethyl cellulose (CMC); rubber resins such as styrene-butadiene rubber (SBR); and mixtures thereof but not particularly limited thereto. It is fine to use all binder resins used in a typical electrochemical capacitor.

Further, the electrode is prepared by coating the electrode active material composition on the current collector prepared according to the present invention with a predetermined thickness, and a method of coating the electrode active material composition is not particularly limited.

Further, a mixture of the electrode active material, the conductive agent, and the solvent is formed into a sheet by the binder resin or a sheet extruded by extrusion is bonded to the current collector by a conductive adhesive.

The separator in accordance with the present invention may use all materials used in a conventional electric double layer capacitor or lithium ion battery, for example, a microporous film manufactured from at least one polymer selected from the group consisting of polyethylene (PE), polypropylene (PP), polyvinylidenfluoride (PVDF), polyvinylidene chloride, polyacrynitril (PAN), polyacrylamide (PAM), polytetrafluoroethylene (PTFE), polysulfone, polyether sulfone (PES), polycarbonate (PC), polyamide (PA), polyimide (PI), polyethyleneoxide (PEO), polypropylene oxide (PPO), cellulose polymer, and polyacrylic polymer. Further, a multilayer film manufactured by polymerizing the porous film may be used, and among them, the cellulose polymer may be preferably used.

It is preferred that a thickness of the separator is about 15 to 35 μm but not limited thereto.

The electrolyte of the present invention may be an organic electrolyte containing at least one selected from non-lithium salts such as TEABF₄ and TEMABF₄; spiro salts; and at least one lithium salt selected from the group consisting of LiPF₆, LiBF₄, LiCLO₄, LiN(CF₃SO₂)₂, CF₃SO₃Li, LiC(SO₂CF₃)₃, LiAsF₆, and LiSbF₆ but not limited thereto.

The solvent of the electrolyte may be at least one selected from the group consisting of acrylonitrile, ethylene carbonate, propylene carbonate, dimethyl carbonate, ethyl methyl carbonate, sulfolane, and dimethoxyethane but not limited thereto. The electrolyte, in which these solute and solvent are mixed, has a high withstand voltage and high electrical conductivity. It is preferred that concentration of an electrolyte salt in the electrolyte is 0.1 to 2.5 mol/L or 0.5 to 2.0 mol/L.

It is preferred that a case (exterior material) of the electrochemical capacitor of the present invention uses an aluminum-containing laminate film, which is typically used in a secondary battery and an electric double layer capacitor, but not particularly limited thereto.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### Embodiment 1

### Preparation of Metal Current Collector

After preparing a plain aluminum foil with a thickness of 25 μm, ultrasonic cleaning is performed for each 20 minutes by sequentially using acetone and ethyl alcohol. The cleaned aluminum foil is treated with fluosilicic acid (H₂SiF₆) along a triple junction line of a surface thereof at 45° C. for 60 seconds to be locally corroded so that grooves are formed on the surface of the aluminum foil. The formed grooves have a depth of 0.5 to 1.0 μm, and an interval between the grooves is 1.0 to 3.0 μm.

Next, AC electrolytic etching is performed at 35° C. for 2 minutes in a mixture of 1.0M hydrochloric acid (HCl) and 0.01M sulfuric acid (H₂SO₄) to remove a native oxide layer. A conductive layer is formed on the aluminum foil, from which the native oxide layer is removed, by coating conductive layer slurry using a comma coater after preparing the conductive layer slurry by mixing and agitating super-p 80 g, CMC 3.5 g and SBR 5.8 g as binders, and water 155 g.

After that, a current collector, on which an electrode is to be coated, is prepared by performing ultrasonic cleaning for each 20 minutes sequentially using acetone and ethyl alcohol again.

### Comparative Example 1

An etched aluminum foil with a thickness of 20 μm is used as a metal current collector.

### Embodiment 2, Comparative Example 2

### Preparation of Electrochemical Capacitor

1) Preparation of Electrode

Electrode active material slurry is prepared by mixing and agitating activated carbon (specific surface area 2150 m²/g) 85 g, super-p 18 g as a conductive agent, CMC 3.5 g, SBR 12.0 g, and PTFE 5.5 g as binders, and water 225 g.

The electrode active material slurry is coated on the metal current collector in accordance with the embodiment 1 and the comparative example 1 by a comma coater, temporarily dried, and cut to an electrode size of 50 mm×100 mm. A cross-sectional thickness of the electrode is 60 μm. Before assembly of a cell, the electrode is dried in a vacuum at 120° C. for 48 hours.

2) Preparation of Electrolyte

An electrolyte is prepared by dissolving a spiro salt in an acrylonitrile solvent so that concentration of the spiro salt is 1.3 mol/L.

3) Assembly of Capacitor Cell

The prepared electrodes (cathode, anode) are immersed in the electrolyte with a separator (TF4035 from NKK, cellulose separator) interposed therebetween and put in a laminate film case to be sealed.

### Experimental Example

### Estimation of Capacity of Electrochemical Capacitor Cell

Capacity of the last cycle is measured by charging a cell to 2.5V at a constant current with a current density of 1 mA/cm² and discharging the cell at a constant current of 1 mA/cm² three times after 30 minutes under the condition of a constant temperature of 25° C., and measurement results are shown in the following table 1.

Further, resistance characteristics of each cell are measured by an ampere-ohm meter and an impedance spectroscopy, and measurement results are shown in the following table 1.

TABLE 1

| | Initial | Resistance |
|---|---|---|
| Classification | Capacity (F) | (AC ESR, mΩ) |
| Comparative Example 2 | 10.55 | 19.11 |
| Embodiment 2 | 12.02 | 15.33 |

As in the results of the table 1, capacity of the comparative example 2, which is an electrochemical capacitor (EDLC cell) including an electrode using a typically used current collector, is 10.55 F and at this time, a resistance value is 19.11 mΩ.

On the other hand, capacity of the embodiment 2, which is an electrochemical capacitor (EDLC cell) including an electrode using a metal current collector including a metal substrate having grooves formed along a triple junction line and a conductive layer formed on the metal substrate like the present invention, is 12.02 F and at this time, a resistance value is 15.33 mΩ.

From these results, it is possible to prepare an electrode capable of reducing resistance per unit volume of a cell and increasing capacity of the cell through surface modification of a current collector as above.

According to the present invention, a metal current collector including a metal substrate having grooves formed along a triple junction line of a surface thereof and a conductive layer formed on the metal substrate has a large surface area and low electrical resistance.

This metal current collector can be effectively used in electrochemical capacitors with high capacity and high output characteristics.

What is claimed is:

1. A metal current collector comprising:
a metal substrate having grooves formed along a triple junction line of a surface thereof; and
a conductive layer formed on the metal substrate having the grooves.

2. The metal current collector according to claim 1, wherein the metal substrate is at least one selected from the group consisting of aluminum, stainless steel, titanium, tantalum, niobium, copper, nickel, and alloys thereof.

3. The metal current collector according to claim 1, wherein the metal substrate is aluminum or an alloy thereof.

4. The metal current collector according to claim 1, wherein the metal substrate has one structure selected from a sheet-like foil structure, an etched foil structure, an expanded metal structure, a punched metal structure, a net structure, and a foam structure.

5. The metal current collector according to claim 1, wherein the grooves formed on the metal substrate have a depth of 0.5 to 1.0 μm.

6. The metal current collector according to claim 1, wherein an interval between the grooves formed on the metal substrate is 1.0 to 3.0 μm.

7. The metal current collector according to claim 1, wherein the conductive layer uses at least one conductive carbon selected from the group consisting of super-p, graphite, cokes, activated carbon, and carbon black.

8. A method for preparing a metal current collector comprising:
forming grooves along a triple junction line of a surface of a metal substrate;
removing a native oxide layer formed on the metal substrate; and
forming a conductive layer on the metal substrate from which the native oxide layer is removed.

9. The method for preparing a metal current collector according to claim 8, wherein the grooves are formed by locally corroding the triple junction line of the metal substrate.

10. The method for preparing a metal current collector according to claim 8, wherein the removal of the native oxide layer is processed by at least one acid solution selected from the group consisting of phosphoric acid, sulfuric acid, nitric acid, hydrochloric acid, acetic acid, carbonic acid, trifluoroacetic acid, oxalic acid, hydrofluoric acid, boric acid, perchloric acid, hypochlorous acid, and mixtures thereof.

11. The method for preparing a metal current collector according to claim 8, wherein the removal of the native oxide layer is processed by at least one alkaline solution selected from the group consisting of potassium hydroxide, sodium hydroxide, lithium hydroxide, ammonia, and mixtures thereof.

12. An electrochemical capacitor comprising a metal current collector according to claim 1.

13. The electrochemical capacitor according to claim 12, wherein the metal current collector is used in one or both selected from a cathode and/or an anode.

14. An electrochemical capacitor comprising an electrode including an electrode active material in a metal current collector according to claim 1.

15. The electrochemical capacitor according to claim 14, wherein the electrode active material is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

16. The electrochemical capacitor according to claim 14, wherein the electrode active material is activated carbon with a specific surface area of 1.500 to 3.000 m²/g.
